(19) United States
(12) Patent Application Publication
(10) Pub. No.: US 2005/0235058 A1
(43) Pub. Date: Oct. 20, 2005

(54) Multi-network monitoring architecture

(76) Inventors: Phil Rackus, Ottawa (CA); Claudiu Carter, Ottawa (CA); Jean Fauteux, Gatineau (CA); Adrian Gilbert, Ottawa (CA)

Correspondence Address: LADAS & PARRY LLP, 224 SOUTH MICHIGAN AVENUE, SUITE 1600, CHICAGO, IL, 60604, US

(21) Appl. No.: 10/961,011

(22) Filed: Oct. 8, 2004

(30) Foreign Application Priority Data
Oct. 10, 2003 (CA) 2,444,834

(51) Int. Cl. G06F 15/173; G06F 11/00

(52) U.S. Cl. 709/224; 714/4

(57) ABSTRACT

A network monitoring architecture for multiple computer network systems is disclosed. In particular, the network monitoring architecture includes an agent system installed within each computer network and a remote central management unit in communication with the agent system of each computer network. The agent systems collect data from key network devices that reside on the corresponding computer network, and send the collected data to the remote central management unit as a message through the Internet. The data from the computer networks are processed at the remote central management unit to determine imminent or actual failure of the monitored network devices. The appropriate technicians can be immediately notified by the central management unit through automatically generated messages.

### FIELD OF THE INVENTION

The present invention relates to computer networks. In particular, the present invention relates to a network monitoring system for maintaining network performance.

### BACKGROUND OF THE INVENTION

Technology has advanced to the state where it is a key enabler for business objectives, effectively creating an important reliance upon technologies such as email, web, and e-commerce for example. Consequently, if the technology fails, the business functions may not be executed efficiently, and in a worst case scenario, they may not be executed at all. Network failure mechanisms are well known to those of skill in the art, and can be caused by malicious “spam” attacks, hardware failure or software failure, for example.

Large companies mitigate these risks through internal information technology (IT) groups, with budgets to support sophisticated systems monitoring solutions. The financial resources required to support an IT group and the required tools in large enterprise, are considerable and unattainable by the small to medium size business (SMB). Since the typical SMB can neither afford nor justify the costs associated with maintaining dedicated technical staff and the monitoring solutions to support them, an opportunity arises for the IT outsourcing business model. With this model an IT company provides IT services to several small companies, which can now effectively share resources, allowing them to compete with their larger, better funded competitors on an even technological landscape.

Unfortunately there are few technology solutions designed to support the IT service provider, and no solutions that are offered as a stand-alone product (as opposed to a subscribed service). These IT service providers require the ability to monitor, manage and report on all of their disparate customer networks without impairing the security of these infrastructures with intrusive monitoring.

Providing a centralized monitoring solution for multiple client networks presents a number of significant technical challenges for most small businesses: Most use low-end commodity hardware which is neither manageable nor robust; Small businesses typically rely on Internet connectivity solutions that are cost effective, but do not provide significant bandwidth or appropriate service levels; Most small businesses are using similar, if not identical, private IP addressing schemes (192.168.xxx.xxx) that make unique identification of devices across networks difficult; There are no margins available to accommodate heavy installation costs, because any major reconfiguration of the monitoring solution and/or the customer network is typically unacceptable. The MSP is not local to the customer network, so any problems that occur must be remotely manageable; Different users of a monitoring system require different representations and access privileges to data. In particular, maximum efficiency is obtained by giving the MSP user the capability to view all of the customer networks as a single entity. However, each of the customers may also wish to view the status of their devices. In this case, for obvious reasons of security and privacy, the customer must never have access to data other than their own, or even be aware of the existence of other customers.

A known solution is a deployed monitoring system that includes an agent residing on the client's server for monitoring specified server functions. Anomalies or problems with the client network are reported to an on-site central management centre for by an IT user to address.

An example of an available network monitoring solution is the Hewlett Packard HP Openview™ system. HP Openview™ is a system that is installed on a subject network for monitoring its availability and performance. In the event of imminent or actual network failure, IT staff is notified so that proper measures can be taken to correct or prevent the failures. Although HP Openview™ and similar solutions perform their functions satisfactorily, they were originally designed under a single Local Area Network (LAN) model and infrastructure, and therefore their use is restricted to single LAN environments. A local area network is defined as a network of interconnected workstations sharing the resources of a single processor or server within a relatively small geographic area. This means that for a service provider to use these solutions in a true managed service provider model (MSP), each customer of the IT outsourcing company would require their own dedicated installation of the network monitoring system. The cost structure associated with this type of deployment model significantly affects the viability of the MSP model.

Therefore, currently available network monitoring systems are not cost-effective solutions for a multi-client, service provider model.

Therefore, there is a need for a low cost network monitoring system that allows the service provider to monitor multiple discrete local area networks of the same client or different clients, from a single system.

### SUMMARY OF THE INVENTION

It is an object of the present invention to obviate or mitigate at least one disadvantage of the prior art. In particular, it is an object of the present invention to provide a centralized network monitoring architecture for monitoring multiple disparate computer networks.

In a first aspect, the present invention provides a network monitoring architecture for a system having a computer network in communication with a public network. The network monitoring architecture includes an agent system and a remote central management unit. The agent system is installed within the computer network for collecting performance data thereof and for transmitting a message containing said performance data over the public network. The remote central management unit is geographically spaced from the computer network for receiving the message and for applying a predefined rule upon said performance data. The remote central management unit provides a notification when a failure threshold corresponding to the predefined rule has been reached.

According to embodiments of the first aspect, the system includes a plurality of distinct computer networks, each computer network having an agent system installed therein for collecting corresponding performance data, and each agent system transmitting a respective message containing performance data to the remote central management unit, and the public network includes the Internet.

According to another embodiment of the present aspect, the agent system includes at least one agent installed upon a component of the computer network for collecting the performance data. In alternate aspects of the present embodiment, the component can include a host system, and the performance data can include host system operation data, or the component can include a network system, and the performance data can include network services data.

In yet another aspect of the present embodiment, the at least one agent can include a module for collecting the performance data from the device, a module management system for receiving the performance data from the module and for encapsulating the performance data in the message, and a traffic manager for receiving and transmitting the message to the remote central management unit. In an alternate embodiment of the present aspect, the module can be selected from the group consisting of a CPU use module, an HTTP module, an updater module, a disk use module, a connection module, an SNMP module, an SMTP module, a POP3 module, an FTP module, an IMAP module, a Telnet module and an SSH module. In further embodiments of the present aspect, the message can be encapsulated in a SOAP message format, and the traffic manager can include a queue for storing the message.

In another embodiment of the first aspect, the agent system includes a plurality of probes for monitoring a plurality of devices of the computer network, and the plurality of probes are arranged in a nested configuration with respect to each other.

In yet another embodiment of the first aspect, the remote central management unit includes a data management system for extracting the performance data from the message and for providing an alert in response to the failure threshold being reached, a data repository for storing the performance data received by the data management system and the predefined rule, a notification system for generating a notification message in response to the alert, and a user interface for configuring the predefined rule and the agent system configuration data, the data management system encapsulating and transmitting the agent system configuration data to the agent system.

In a second aspect, the present invention provides a method of monitoring a computer network from a remote central management unit, the computer network having an agent system for collecting performance data thereof, and the remote central management unit having rules with corresponding failure thresholds for application to the performance data. The method includes the steps of transmitting the performance data to the remote central management unit over a public network, applying the rules to the performance data, and providing a notification in response to the failure threshold corresponding to the rule being reached.

According to embodiments of the second aspect, the step of transmitting includes encapsulating the performance data into a message prior to transmission to the remote central management unit, where the message is encapsulated in a SOAP messaging format, and the step of applying is preceded by extracting the performance data from the message.

According to other embodiments of the second aspect, the rules and corresponding failure thresholds are configured through a web-based user interface, the message is transmitted over the Internet, the performance data and rules are stored in a data repository of the remote central management unit, the notification can include email messaging or wireless communication messaging.

In yet another embodiment of the second aspect, the method further includes the step of configuring the agent system. The step of configuring can include setting configuration data through a web-based user interface, and transmitting the configuration data to the agent system. The configuration data can be encapsulated in a SOAP message format.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates an overview of the network monitoring architecture according to an embodiment of the present invention;

FIG. 2 shows a block diagram of the components of the network monitoring architecture according to an embodiment of the present invention; and, FIG. 3 shows details of the probe shown in FIG. 2.

### DETAILED DESCRIPTION

A centralized network monitoring architecture for multiple computer network systems is disclosed. In particular, the network monitoring architecture includes an agent system installed within each computer network and a remote. central management unit in communication with the agent system of each computer network. The agent system collects data from key network devices that reside on the computer network, and sends the collected data to the remote central management unit as messages through a public communications network, such as the Internet or any suitable publicly available network. The data from the computer networks are processed at the remote central management unit to determine imminent or actual failure of the monitored network devices by applying rules with corresponding failure thresholds. The appropriate technicians can then be immediately notified by the central management unit through automatically generated messages. Because the data processing system, hardware and software resides at the remote central management unit, they are effectively shared by all the computer networks. Therefore, multiple distinct client computer networks can be cost effectively monitored by the centralized network monitoring architecture according to the embodiments of the present invention.

One application of the network monitoring architecture contemplated by the embodiments of the present invention is to provide IT infrastructure management. More specifically, businesses can properly manage or monitor all of their IT hardware and software to avoid and minimize IT service failures, which can be costly when customers are lost due to such failures. Since much of the network system monitoring is automated, the costs to the business are decreased because less technical staff are required to maintain and administer the network when compared to businesses who do not utilize automated IT infrastructure management.

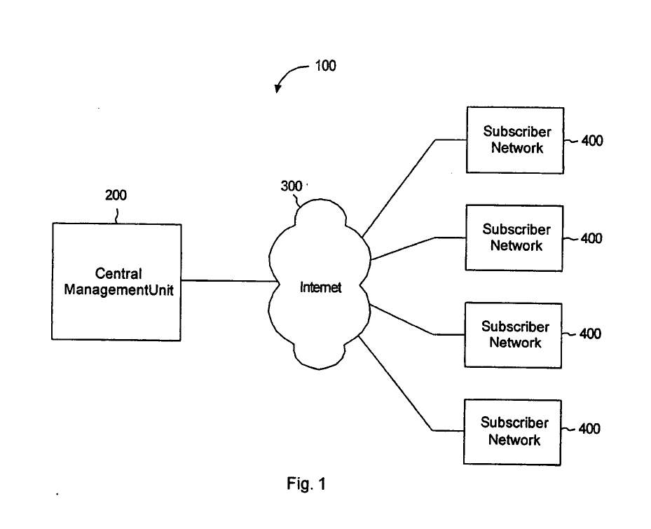

FIG. 1 shows a block diagram of the network monitoring architecture according to an embodiment of the present invention. In general, the network monitoring architecture monitors key network elements on one or more subscriber computer networks, and notifies the subscriber user in the event of an imminent failure or alarm. A subscriber user can be a network administrator or any person responsible for the maintenance of the subscriber computer network. A key network element can be an element that is important to the operations of a computer network or business, and can be a server, switch, router or any item, device or node with an IP address.

Network monitoring architecture 100 includes a remote central management unit 200 in communication with the Internet 300. A plurality of distinct client subscriber computer networks 400 are in communication with the Internet 300. In the present example each subscriber computer network 400 and the central management unit 200 are geographically separate from each other, however, communications between central management unit 200 and each subscriber computer network 400 can be maintained through their connections to the Internet 300. As will be shown later, each subscriber computer network 400 has an agent system installed upon it for monitoring specific parameters related to the respective network. Each agent system can be configured differently for monitoring user specified parameters, and is responsible for collecting and sending performance data to the central management unit 200. According to the present embodiment, the data can be encapsulated in well known message formats. Central management unit 200 receives the messages for processing according to predefined user criteria and failure thresholds. For example, the performance data collected for a particular subscriber computer network 400 can be analysed through the application of data functions to determine if predetermined performance thresholds have been reached. An example of a performance threshold can be the remaining hard drive space of a particular device. The failure threshold for remaining hard drive space can be set to be 10% for example. In the event of any failure threshold being reached, the central management unit 200 sends immediate notification to the appropriate IT personnel to allow them to take preventative measures and return their computer network to optimum operating functionality. Although only four subscriber computer networks 400 are shown in FIG. 1, there can be many additional subscriber computer networks 400 in communication with the remote central management unit 200.

The subscriber computer networks 400 can include different client LAN's, or a wide area network (WAN). The remote central management unit 200 is not a part of any client subscriber network, and hence does not necessarily reside on any subscriber computer network 400 site. The remote central management unit 200 can be located at a site geographically distant from all the subscriber computer networks 400. Since central management unit 200 is off site and external to its subscriber computer networks 400, network monitoring is performed remotely.

One message format that can be used for communicating performance data are SOAP messages. SOAP is based upon XML format, and is a widely used messaging protocol developed by the W3C. SOAP is a lightweight protocol for exchange of information in a decentralized, distributed environment. The SOAP protocol consists of three parts: an envelope that defines a framework for describing what is in a message and how to process it, a set of encoding rules for expressing instances of application-defined data types, and a convention for representing remote procedure calls and responses. SOAP can potentially be used in combination with a variety of other protocols. According to the present embodiments of the invention, SOAP is used in combination with HTTP and HTTP Extension Framework. Those of skill in the art will understand that any suitable message format can be used instead of the SOAP message format in alternate embodiments of the present invention.

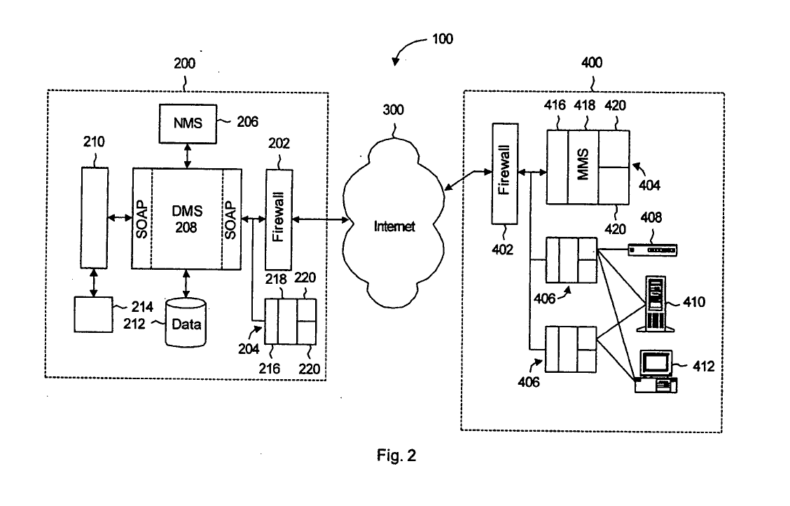

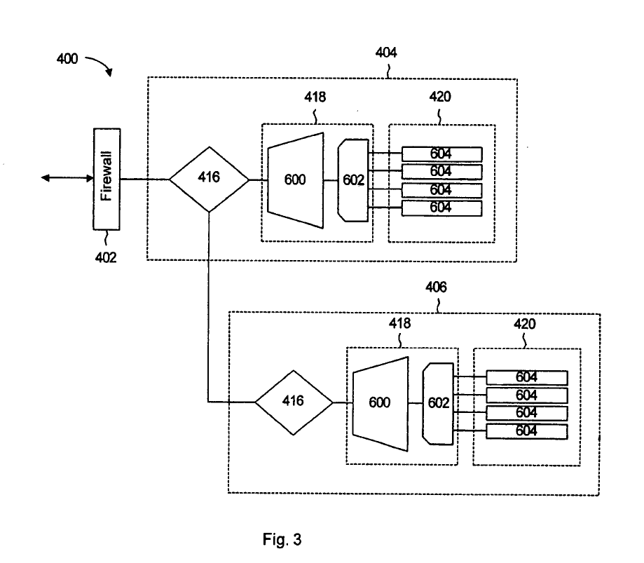

A detailed block diagram of the components of the network monitoring architecture 100 is shown in FIG. 2. In particular, the details of central management unit 200 and one subscriber computer network 400 of FIG. 1 according to an embodiment of the present invention are shown.

Central management unit 200 includes a firewall 202, a probe agent 204 a notification management system (NMS) 206, a data management system (DMS) 208, a web interface engine 210, a data repository 212 and a user interface 214. The firewall 202 is located between DMS 208 and the subscriber computer network 400 to ensure secure communications between central management unit 200 and all subscriber computer networks 400.

Agent 204 includes a traffic manager 216, a module management system (MMS) 218, and module blocks 220. The MMS 218 manages the monitoring tasks that have been defined for it, including scheduling, queuing and communications. MMS 218 calls modules from the module blocks 220 to perform specific tasks. Each module block 220 includes individual modules that collect information from the Internet for the traffic manager 216. The traffic manager 216, specifically the MMS 218, is responsible for coordinating the flow of data between the modules and a central server of the subscriber computer network 400, as well as controlling operations of module blocks 220. The component details of the agent 204 will be described later.

The user interface 214 is generated as dynamic HTML, and does not require special client side components, such as plug-ins, JAVA™ TM etc., in order to gain access to the web interface engine 210 and enter configuration data to, or receive desired information from, the data repository 212. Through the user interface, provided via a standard web server 214, the subscriber user is able to configure the probes residing in their computer networks 400 at any time. For example, the subscriber user can add or remove specific modules from specific devices and change the nature of specific tasks such polling interval, and test parameters.

The NMS 206 is responsible for notifying a subscriber user whenever a warning condition arises as determined by the DMS 208, as well as providing extended functionality such as time-based escalations whereby additional or alternate resources are notified based on the expiry of a user-defined period. The DMS 208 can provide an alert to signal NMS 206 to generate the appropriate notification. Notification can be provided by any well known means of communication, such as by email messaging and wireless messaging to a cell phone or other electronic device capable of wireless communication. Those of skill in the art will understand that NMS 206 can include well known hardware and software to support any desired messaging technology. The notification can include an automatically generated message alerting the IT user of the problem or a brief message instructing the IT user to access the network monitoring system via the user interface 214 to obtain further details of the problem.

The DMS 208 is a data analysis unit responsible for executing rules upon data received in real time from computer subscriber network 400, data from the data repository 212, or data generated from the user interface 214 and includes a pair of SOAP traffic managers to facilitate data exchange into and out of the central management unit 200, as well as providing a SOAP interface to other internal or external application modules. Incoming SOAP messages are processed such that the encapsulated performance data is extracted for analysis, and outgoing configuration data and information are encapsulated in the SOAP format for transmission. Accordingly, those of skill in the art will understand that particular rules can be executed at different times depending upon the nature of the performance data. For example, when a module reports that remaining hard drive space has reached 2%, the appropriate rule and corresponding failure threshold of 10% is immediately applied. On the other hand, a stored history of bandwidth data can be acted upon at predetermined intervals to determine trends. DMS 208 receives configuration data from an IT user via user interface 214 and web interface engine 210. The configuration data can include user defined rules for application by DMS 208, probe configuration data for installing and controlling the probes and associated modules of computer subscriber network 400. Once rules are configured and probes and modules are installed, network monitoring can proceed. Performance data collected by the probes for its associated computer subscriber network 400 are received by DMS 208 and stored in data repository 212. The data is then retrieved from data repository 212 as required for application of the rules. Any rule that is “broken” triggers DMS 208 to prepare a notification message for one or more IT users responsible for the computer subscriber network 400. DMS 208 then instructs NMS 206 to send a message to the IT user regarding the problem corresponding to the rule. In this particular example, DMS 208 sends and receives data in the SOAP format.

The subscriber computer network 400 is now described. The computer network includes a firewall 402 and an agent system consisting of probes 404 and agents 406 installed on dedicated components/devices for the purpose of monitoring multiple components/devices within the subscriber computer network 400. A probe is a type of agent which is architecturally the same as an agent, with the only differences being that agents reside within a pre-selected component/device within the customer infrastructure for the purpose of monitoring the specific host device and probes reside on their own hardware for the purpose of monitoring multiple devices/components within the customer infrastructure. In this particular example, probe 404 is a network services monitoring probe that can be installed within a system responsible for managing network services that are hosted by remote devices, as seen from the perspective of the probe 404, such as web services, network connectivity, etc. An example of such a system can include a network server for example. Agent 406 is a device monitoring probe that can be installed within one device for monitoring services or operations of the host system, such as CPU utilization and memory utilization for example. An example of such devices can include a desktop PC, a windows server or a Sun Solaris™ server.

In the present example, probes 404 reside on a server for monitoring specific functions of hub 408, tower box 410 and workstation 412, where each probe 406 can monitor different functions of any single device. It should be noted that probes 404 and 406 are the same as probe agent 204 and therefore include the same functional components. More specifically as exemplified by probe 404, each of probes 404 and agents 406 includes a traffic manager 416, a module management system (MMS) 418, and module blocks 420, which correspond in function to the traffic manager 216, the module management system (MMS) 218, and module blocks 220 of probe 204 respectively. Probes 404 and agents 406 communicate in parallel with remote central management unit 200 to ensure efficient and rapid communication of data between probes 404, agents 406 and the central management unit 200. As will be shown later, the probes can be nested to provide reliable communication of data to the central management unit 200 in the event that Internet communications becomes unavailable. It should be noted that the configuration of subscriber computer network 400 of FIG. 2 is exemplary, and other computer networks can have their agent systems configured differently.

In operation, each agent or probe automatically sends data corresponding to the device it is monitoring to the central management unit 200 through the Internet 300, for storage if required, and processing by DMS 208. Imminent and immediate failures of any monitored device of subscriber computer network 400 as determined by DMS 208 are communicated to IT users of the particular subscriber computer network 400 through NMS 206. In the case of imminent failure of a particular device, the IT user can be warned in advance to correct the problem and avoid costly and frustrating network down time. Furthermore, since the network monitoring architecture according to the embodiments of the present invention is a centralized system, multiple subscriber computer networks 400 can be serviced in the same way, and in parallel.

FIG. 3 shows a block diagram of two probes installed within a subscriber computer network 400, such as the computer networks 400 shown in FIGS. 1 and 2. In this particular example, probes are nested within different aspects of the customer infrastructure, however, communication with the remote central management unit 200 always occurs in a parallel fashion, such that each probe 404 and 406 communicates independently with the remote central management unit 200 regardless of the physical deployment. The nested configuration of probes 404 and 406 corresponds to that of probes 404 and 406 shown in FIG. 2. In FIG. 3, the details of traffic manager 416, MMS 418, and module blocks 420 for probes 404 and 406 are shown in further detail.

Traffic manager 416 is responsible for receiving local message data from its respective MMS 418 and external message data from another probe, such as probe 406, and queuing the received data if necessary, for transmission through the Internet 300 as SOAP message data packets. Traffic manager 416 also receives configuration data from the Internet 300 for distribution to the addressed probe. As previously mentioned, these SOAP data packets are specially designed for use over HTTP or HTTPS in the present embodiments of the invention. As previously mentioned, the traffic manager 416 can queue data intended for transmission to the remote central management unit 200. This feature enables probe 404 to retain collected data when the Internet becomes unavailable to traffic manager 416. Otherwise, the transmitted data could be indefinitely lost. In such a circumstance, transmission of outgoing data is halted and the data queued until the Internet becomes available. When transmission resumes, the queued data is transmitted to the central management unit 200, as well as more recently collected data. Since probes can be nested as shown in FIG. 3, each probe has its own traffic queue. Those of skill in the art will understand that the queues of nested probes can be emptied in any desired order. The queues can be configured as a first-in-first-out queue to ensure the original sequence of data transmission is maintained.

MMS 418 includes a process manager 600 and a module Application Programming Interface (API) 602. Process manager 600 is responsible for controlling the modules in module block 420. For example, process manager 600 starts and stops individual modules, sends data to and receives data from the individual modules, and allows parallel execution of multiple modules. For SOAP data messages coming in from the Internet 300 via the traffic manager 416, called queued incoming data, process manager 600 unwraps the queued incoming data and forwards it to the appropriate module. For data going out to the Internet 300, the process manager 600 receives outgoing data such as data from a module, and prepares the outgoing data for transmission through the Internet by encapsulating the data in SOAP data packets. The functions of the process manager 600 are similar to those of an operating system. It provides an interface to the individual modules and the traffic manager 416. In addition to processing and passing data messages between the traffic manager 416 and the modules, process manager 600 manages the modules and the traffic manager 416.

API 602 defines the ways a program running on that system can legitimately access system services or resources. API 602 is an interface that allows the process manager 600 to communicate with the individual modules in the module block 420. The API's are defined interfaces that enable functionality of the probe.

Module block 420 includes a number of individual modules 604, each responsible for collecting performance data from specific devices. Although four modules 604 are shown coupled to API 602, process manager 600 and API 602 can control any number of modules 604. Examples of types of modules 604 can include a CPU use module, an HTTP module, an updater module, a disk use module, a connection module and an SNMP module. These modules are representative of the type of data collection functionality available, but do not represent an exhaustive list of monitoring modules. Generally, any current or future device can have an associated module for collecting its device-specific performance data.

The function of the disk use module and the SNMP module are further discussed to illustrate the type of performance data that can be collected. The disk use module checks the remaining capacity of a hard disk drive, and reports the percentage of the drive that is full or the percentage of the drive that is empty. The SNMP module returns the value of any SNMP MIB object on an enabled device, such as a printer or router.

Examples of additional modules include SMTP, POP3, FTP, IMAP, Telnet and SSH modules. The SMTP (Simple Mail Transport Protocol) module checks the status of email systems running under SMTP. POP3 (Post Office Protocol 3) is a mail transport protocol used for receiving email, and the POP3 module checks if email is being properly received. The FTP (File Transfer Protocol) module checks if the FTP server is naming or not. FTP is a means of transferring files to and from a remote server. The IMAP (Internet Message Access Protocol) module checks the status of the IMAP process, which is typically used for mail. The Telnet module monitors the telnet port to ensure that it is up and running. SSH (Secure Shell) is a secure version of telnet, and the SSH module performs the same function as the Telnet module.

The general procedure for monitoring subscriber computer networks that are geographically spaced from the remote central management unit is as follows, assuming that the agent system has been installed upon the subscriber computer networks and the rules and their corresponding failure thresholds have been configured. Once initiated, the agent systems commence collection of performance data from its subscriber computer network. Each agent system then generates messages encapsulating the performance data for transmission to the remote central management unit through the Internet. Once received, the remote central management unit extracts the performance data from the message and applies the appropriate rule or rules to the performance data. The remote central management unit provides notification in the form of an email message or a wireless communication message in response to the failure threshold corresponding to the rule being reached.

An advantage of using multiple, independent agents and probes for the purpose. of monitoring multiple disparate locations is that it provides a remote, or virtual, service provider with the ability to monitor multiple subscriber computer networks from a single central point of management. This allows for streamlined efficiency, increased capacity and consistency of service between subscribers, without requiring any reconfiguration or manipulation of the subscribers' existing infrastructure. This, in turn, allows the service provider to view all aspects of all of their subscriber computer networks as a single entity, while still allowing the subscriber to relate to their network as a separate system, all using the same monitoring solution.

Since probes include their own operating system, they can operate independently of platforms such as Windows, Linux, Unix etc., used by the subscriber networks. Furthermore, standard interfaces such as SNMP do not require direct contact with the OS, and agents can be provided for a range of platforms. Therefore, the monitoring architecture embodiments of the present invention can accommodate subscriber networks that may be running different platforms and/or multiple OS platforms.

The above-described embodiments of the invention are intended to be examples of the present invention. Alterations, modifications and variations may be effected the particular embodiments by those of skill in the art, without departing from the scope of the invention which is defined solely by the claims appended hereto.

1. A network monitoring architecture for a system having a computer network in communication with a public network, comprising:
an agent system installed within the computer network for collecting performance data thereof and for transmitting a message containing said performance data over the public network; and,
a remote central management unit geographically spaced from the computer network for receiving the message and for applying a predefined rule upon said performance data, the remote central management unit providing a notification when a failure threshold corresponding to the predefined rule has been reached.

2. The network monitoring architecture of claim 1, wherein the system includes a plurality of distinct computer networks, each computer network having an agent system installed therein for collecting corresponding performance data, each agent system transmitting a respective message containing performance data to the remote central management unit.

3. The monitoring architecture of claim 1, wherein the public network includes the Internet.

4. The network monitoring architecture of claim 1, wherein the agent system includes at least one agent installed upon a component of the computer network for collecting the performance data.

5. The network monitoring architecture of claim 4, wherein the component includes a host system, and the performance data includes host system operation data.

6. The network monitoring architecture of claim 4, wherein the component includes a network system, and the performance data includes network services data.

7. The network monitoring architecture of claim 4, wherein the at least one agent includes
a module for collecting the performance data from the device,
a module management system for receiving the performance data from the module and for encapsulating the performance data in the message, and
a traffic manager for receiving and transmitting the message to the remote central management unit.

8. The network monitoring architecture of claim 7, wherein the module is selected from the group consisting of a CPU use module, an HTTP module, an updater module, a disk use module, a connection module, an SNMP module, an SMTP module, a POP3 module, an FTP module, an IMAP module, a Telnet module and an SSH module.

9. The network monitoring architecture of claim 7, wherein the message is encapsulated in a SOAP message format.

10. The network monitoring architecture of claim 7, wherein the traffic manager includes a queue for storing the message.

11. The network monitoring architecture of claim 1, wherein the agent system includes a plurality of probes for monitoring a plurality of devices of the computer network.

12. The network monitoring architecture of claim 11, wherein the plurality of probes are arranged in a nested configuration with respect to each other.

13. The network monitoring architecture of claim 1, wherein the remote central management unit includes
a data management system for extracting the performance data from the message and for providing an alert in response to the failure threshold being reached,
a data repository for storing the performance data received by the data management system and the predefined rule,
a notification system for generating a notification message in response to the alert, and
a user interface for configuring the predefined rule and the agent system configuration data, the data management system encapsulating and transmitting the agent system configuration data to the agent system.

14. A method of monitoring a computer network from a remote central management unit, the computer network having an agent system for collecting performance data thereof, and the remote central management unit having rules with corresponding failure thresholds for application to the performance data, the method comprising the steps of:
a) transmitting the performance data to the remote central management unit over a public network;
b) applying the rules to the performance data; and
c) providing a notification in response to the failure threshold corresponding to the rule being reached.

15. The method of claim 14, wherein the step of transmitting includes encapsulating the performance data into a message prior to transmission to the remote central management unit.

16. The method of claim 15, wherein the message is encapsulated in a SOAP messaging format.

17. The method of claim 15, wherein the step of applying is preceded by extracting the performance data from the message.

18. The method of claim 14, wherein the rules and corresponding failure thresholds are configured through a web-based user interface.

19. The method of claim 14, wherein the message is transmitted over the Internet.

20. The method of claim 14, wherein the performance data and rules are stored in a data repository of the remote central management unit.

21. The method of claim 14, wherein the notification can include email messaging.

22. The method of claim 14, wherein the notification can include wireless communication messaging.

23. The method of claim 14, further including a step of configuring the agent system.

24. The method of claim 23, wherein the step of configuring includes
i) setting configuration data through a web-based user interface, and
ii) transmitting the configuration data to the agent system.

25. The method of claim 24, wherein the configuration data is encapsulated in a SOAP message format.

26. An article of manufacture for controlling a data flow in a data network, the article of manufacture comprising:
at least one processor readable carrier and instructions carried on the at least one carrier; wherein the instructions are configured to be readable from the at least one carrier by at least one processor and thereby cause the at least one processor to operate so as to monitor a computer network from a remote central management unit, the computer network having an agent system for collecting performance data thereof, and the remote central management unit having rules with corresponding failure thresholds for application to the performance data, by performing the steps of:
a) transmitting the performance data to the remote central management unit over a public network;
b) applying the rules to the performance data; and
c) providing a notification in response to the failure threshold corresponding to the rule being reached.

27. A signal embodied in a carrier wave and representing sequences of instructions which, when executed by at least one processor, cause the at least one processor to control a data flow so as to monitor a computer network from a remote central management unit, the computer network having an agent system for collecting performance data thereof, and the remote central management unit having rules with corresponding failure thresholds for application to the performance data, by performing the steps of:
a) transmitting the performance data to the remote central management unit over a public network;
b) applying the rules to the performance data; and
c) providing a notification in response to the failure threshold corresponding to the rule being reached.
